(19) United States
(12) Patent Application Publication
(10) Pub. No.: US 2025/0329843 A1
(43) Pub. Date: Oct. 23, 2025

(54) BATTERY MODULE FOR BATTERY BREAKAGE PREVENTION

(71) Applicant: LG ENERGY SOLUTION, LTD., Seoul (KR)

(72) Inventors: Jeong Hoon PARK, Daejeon (KR); Jun Kyu PARK, Daejeon (KR); Je Hwan SIN, Daejeon (KR); Jung Woo CHOI, Daejeon (KR)

(73) Assignee: LG ENERGY SOLUTION, LTD., Seoul (KR)

(21) Appl. No.: 18/699,727

(22) PCT Filed: Dec. 2, 2022
(86) PCT No.: PCT/KR2022/019517

§ 371 Date: Nov. 5, 2024

(30) Foreign Application Priority Data
Dec. 17, 2021 (KR) 10-2021-0182156

(51) Int. Cl. H01M 50/242; H01M 50/211; H01M 50/244; H01M 50/507

(52) U.S. Cl. CPC H01M 50/242; H01M 50/244; H01M 50/507; H01M 50/211

(57) ABSTRACT

A battery module may include a plurality of batteries, an accommodation part formed to accommodate the plurality of batteries, a first frame formed to cover an upper portion of the accommodation part and support a busbar electrically connected to the plurality of batteries through a connection part, and a second frame formed to cover a lateral portion of the accommodation part and coupled to the first frame. The second frame may include a first member coupled to the first frame, and a second member coupled to the first member to be rotatable with respect to the first member in a direction in which the connection part applies force according to a change in volume of the plurality of batteries.

### TECHNICAL FIELD

### Cross-reference to Related Applications

The present application claims the benefit of the priority of Korean Patent Application No. 10-2021-0182156, filed on Dec. 17, 2021, which is hereby incorporated by reference in its entirety.

### Technical Field

The present invention relates to a battery module for breakage prevention, and more particularly, to a battery module capable of preventing secondary battery breakage caused by swelling in advance.

### BACKGROUND ART

As development for alternative energy is essentially required for reasons such as environmental pollution or oil depletion, research on and development for power generation technologies based on energy sources such as solar heat, water power, wind power, ocean energy, and biomass energy, are carried out. In particular, researches on secondary batteries that can be repeatedly charged are actively carried out, and development is carried out on various aspects such as the materials, efficiency, structures, stability, and systems of the secondary batteries.

Secondary batteries in various types such as a pouch type, a prismatic type or a cylindrical type, are applied to electronic systems such as vehicles, mobile phones and notebook computers. A battery pack, which is a set of battery modules appropriately designed for each of the types, is mounted and utilized in an electronic system.

As the plurality of secondary batteries are used in the electronic system for a long time, users and developers have growing perceptions of stability, and there is an increasing demand for stability management not only during manufacture of the secondary batteries, but also during utilization thereof.

According to the related art, however, a swelling phenomenon in which the secondary batteries swell may occur because of failing to completely remove gas in the secondary batteries during the manufacture or evaporation of an electrolyte in the secondary batteries during the utilization of the secondary batteries. The swelling may also occur even when the secondary batteries are maintained in an overcharge or overdischarge state for a long time, are impacted, or become old. When the swelling is neglected, there is a risk of breakage of the secondary batteries or an occurrence of a fire or explosion in the battery modules because of the breakage.

### DISCLOSURE OF THE INVENTION

### Technical Problem

An object to be solved by the present invention is to provide a battery module having an adaptive structure capable of securing an extra space so that breakage of secondary batteries does not occur because of a battery module structure when swelling occurs in the plurality of secondary batteries mounted in the battery module.

### Technical Solution

A battery module according to an embodiment of the present invention may include a plurality of batteries, an accommodation part formed to accommodate the plurality of batteries, a first frame formed to cover an upper portion of the accommodation part and support a busbar electrically connected to the plurality of batteries through a connection part, and a second frame formed to cover a lateral portion of the accommodation part and coupled to the first frame. The second frame may include a first member coupled to the first frame, and a second member coupled to the first member so as to be rotatable with respect to the first member in a direction in which the connection part applies force according to a change in volume of the plurality of batteries.

The battery module may include a coupling shaft that allows the second member to be rotatable with respect to the first member.

Each of the plurality of batteries may each include a battery body and a battery terrace, and the a lead that may electrically connect the busbar to each of the plurality of batteries. The battery terrace and the lead may form the connection part.

The lead may connect the busbar and a first battery cell of the plurality of batteries through a connection space provided between the first frame and the second frame.

When the volume of the first battery is increased above a predetermined volume, the connection part may be in contact with the second frame to apply the force to the second frame and thus, the second member may rotate with respect to the first member in a direction in which the force is applied.

An outermost battery of the plurality of batteries, which is disposed at an outermost side of the plurality of batteries, may be disposed to be adjacent to the second frame.

The first member may be coupled to the first frame so as to be rotatable with respect to the first frame in the direction in which the connection part applies the force.

A module frame according to an embodiment of the present invention may include an accommodation part that accommodates a plurality of batteries, a first frame formed to cover an upper portion of the accommodation part and support a busbar from a lower side, and a second frame formed to cover a lateral portion of the accommodation part and coupled to the first frame. The second frame may include a first member coupled to the first frame, and a second member coupled to the first member so as to be rotatable with respect to the first member in a direction in which an external force is received.

The first member may be coupled and fixed to the first frame.

The first member may be coupled to the first frame so as to be rotatable with respect to the first frame in the direction in which the external force is received.

The second member may be pin-hook-coupled to the first member.

### Advantageous Effects

According to the present invention, even when the volume of the secondary battery is increased because of the swelling, the extra space may be secured in the battery module to prevent the breakage of the secondary battery.

According to the present invention, the structure of the battery module may also adaptively change to cope with the change in the volume of the secondary battery according to the swelling, thereby preventing the breakage of the secondary battery.

According to the present invention, as the breakage of the secondary battery is prevented, the risk of the occurrence of the fire or the explosion in the battery module may be reduced.

### BRIEF DESCRIPTION OF THE DRAWINGS

FIG. 1 is a view illustrating one aspect of a battery module according to an embodiment of the present invention.

FIG. 2 is a view illustrating another aspect of a battery module according to an embodiment of the present invention.

FIG. 3 is a view illustrating a portion of a combinational relationship of a battery module according to an embodiment of the present invention.

FIG. 4 is a view schematically illustrating a portion of a combinational relationship of a battery module according to another embodiment of the present invention.

FIG. 5 is a view illustrating a principle of structural change during swelling of a battery module according to another embodiment of the present invention.

FIG. 6 is a view illustrating a coupling shaft of a battery module according to embodiments of the present invention.

FIG. 7 is a view illustrating a portion of a combinational relationship of a battery module according to another embodiment of the present invention.

### MODE FOR CARRYING OUT THE INVENTION

Hereinafter, H preferred embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. Like reference numerals refer to like elements throughout the whole specification.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

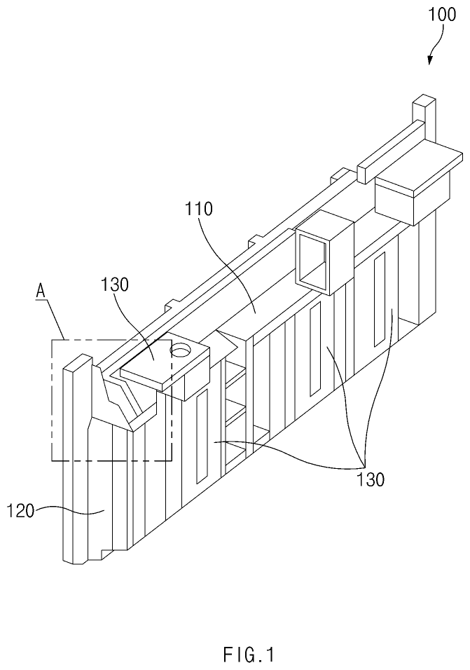

FIG. 1 is a view illustrating one aspect of a battery module 100 according to an embodiment of the present invention.

The battery module 100 may include an accommodation part 101. For example, the accommodation part 101 may accommodate a plurality of batteries 200, and the plurality of batteries 200 may be mounted in an inner space of the accommodation part 101. The plurality of batteries 200 may be secondary batteries.

The battery module 100 may include a plurality of frames 110 and 120.

The plurality of frames 110 and 120 may include a first frame 110. For example, the first frame 110 may cover an upper portion of the accommodation part 101.

The plurality of frames 110 and 120 may include a second frame 120. For example, the second frame 120 may cover a lateral portion of the accommodation part 101.

The first frame 110 and the second frame 120 may be formed in a shape surrounding the accommodation part 101. For example, the first frame 110 may cover the upper portion of the accommodation part 101 and the second frame 120 may cover the lateral portion of the accommodation part 101, thereby surrounding the accommodation part 101.

The first frame 110 may be coupled to the second frame 120.

A busbar 130 may be disposed on the first frame 110. For example, as the busbar 130 is disposed on the first frame 110, the first frame 110 may support the busbar 130. The busbar 130 may electrically connect the battery module 100 and the outside to each other.

The accommodation part 101, the first frame 110, and the second frame 120 may form a busbar frame. The busbar frame may include the busbar 130.

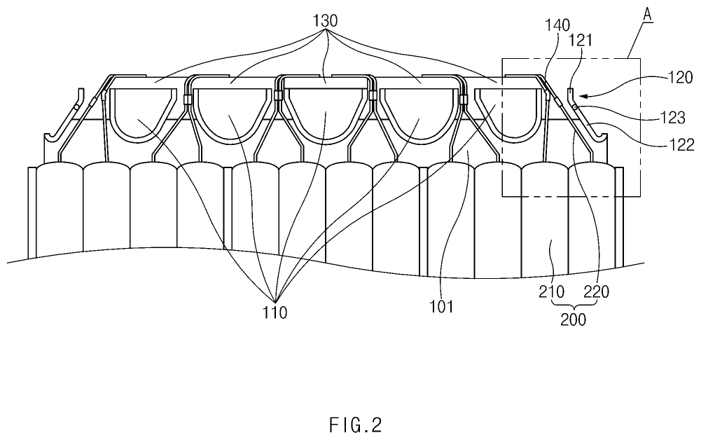

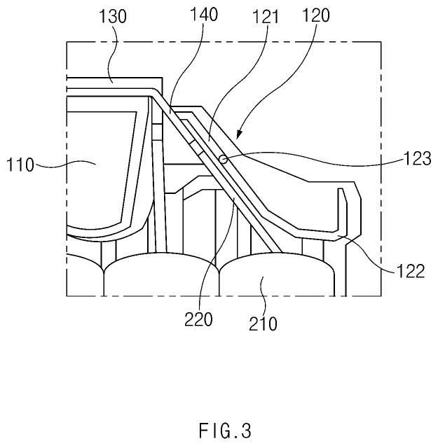

FIG. 2 illustrates another aspect of a battery module 100 according to an embodiment of the present invention. FIG. 3 illustrates a portion (a region A) of a combinational relationship of the battery module 100 according to an embodiment of the present invention.

A plurality of batteries 200 may be mounted in an accommodation part 101 of the battery module 100.

The plurality of batteries 200 may each include a battery body 210 and a battery terrace 220. For example, the battery body 210 may at least include an electrode assembly in which a negative electrode and a positive electrode are stacked alternately with a separator therebetween. The battery terrace 220 may electrically connect the battery body 210 (or the electrode assembly included in the battery body 210) and the outside to each other.

The accommodation part 101 may have an upper portion covered by a first frame 110, and a lateral portion covered by a second frame 120. A busbar 130 may be disposed on the first frame 110. The busbar 130 may be connected to a lead. The busbar 130 may be electrically connected to the batteries 200 through the lead 140. For example, the busbar 130 may be electrically connected to the lead 140, and the lead 140 may be electrically connected to the battery terrace 220. Accordingly, the busbar 130 may be electrically connected to the batteries 200.

The lead 140 and the battery terrace 220, through which the busbar 130 and the plurality of batteries 200 are electrically connected to each other, may be referred to as a connection part. For example, the lead 140 and the battery terrace 220 may form the connection part, and the busbar 130 and the plurality of batteries 200 may be electrically connected to each other through the connection part.

The first frame 110 may include a connection space. For example, the lead 140 may electrically connect the busbar 130 and the plurality of batteries 200 to each other through the connection space formed in the first frame 110.

A connection space may be provided also between the first frame 110 and the second frame 120. For example, the lead 140 may electrically connect the busbar 130 and the plurality of batteries 200 to each other through the connection space provided between the first frame 110 and the second frame 120.

The first frame 110 may cover the upper portion of the accommodation part 101, and the second frame 120 may cover the lateral portion of the accommodation part 101.

The outermost battery of the plurality of batteries 200 mounted in the accommodation part 101, which is disposed at the outermost side, may be disposed to be adjacent to the second frame 120.

The first frame 110 may be coupled to the second frame 120. For example, the first frame 110 may have an edge coupled to the second frame 120.

A combinational relationship between the first frame 110 and the second frame 120 will be described in more detail with reference to the region A.

The second frame 120 may include a first member 121. For example, the first member 121 may be coupled to the first frame 110.

The second frame 120 may include a second member 122. For example, the second member 122 may be coupled to the first member 121 so as to be rotatable with respect to the first member 121.

The second frame 120 may include a coupling shaft 123. For example, the second member 122 may rotate with respect to the first member 121 by the coupling shaft 123.

The accommodation part 101, the first frame 110, and the second frame 120 may form a busbar frame. The busbar frame may include the busbar 130.

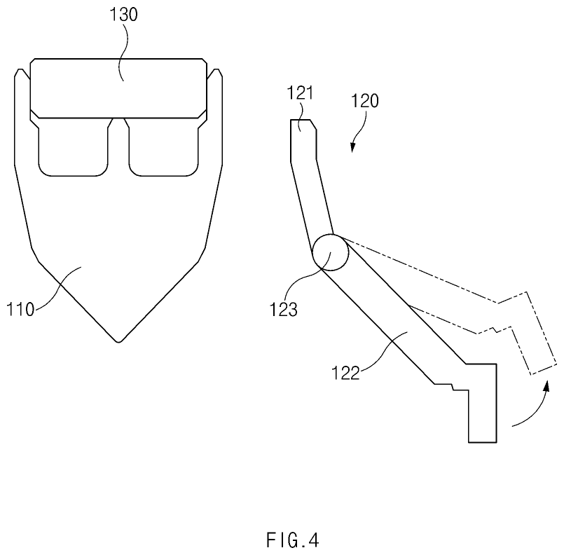

FIG. 4 schematically illustrates a portion of a combinational relationship of a battery module according to another embodiment of the present invention. In order to easily explain a position relationship between a first frame 110 and a second frame 120, other components may be omitted in FIG. 4.

The first frame 110 may be coupled to the second frame 120.

The second frame 120 may include a first member 121, a second member 122, and a coupling shaft 123.

The first member 121 may be coupled to the first frame 110 and fixed to the first frame 110. For example, the first member 121 may be coupled and fixed to an edge of the first frame 110.

The first member 121 may be coupled to the second member 122. For example, the second member 122 may be coupled to the first member 121 so as to be rotatable with respect to the first member 121.

The second member 122 may rotate based on the first member 121 in a direction in which external force is received. For example, when force is applied to the second member 122 from the outside, the second member 122 may rotate based on the first member 121 in a direction in which the force is applied.

The first member 121 and the second member 122 may be coupled to each other through the coupling shaft 123. For example, the coupling shaft 123 may allow the second member 122 to be rotatably coupled to the first member 121.

The second member 122 may rotate around the coupling shaft 123 as a rotary shaft in the direction in which the external force is received.

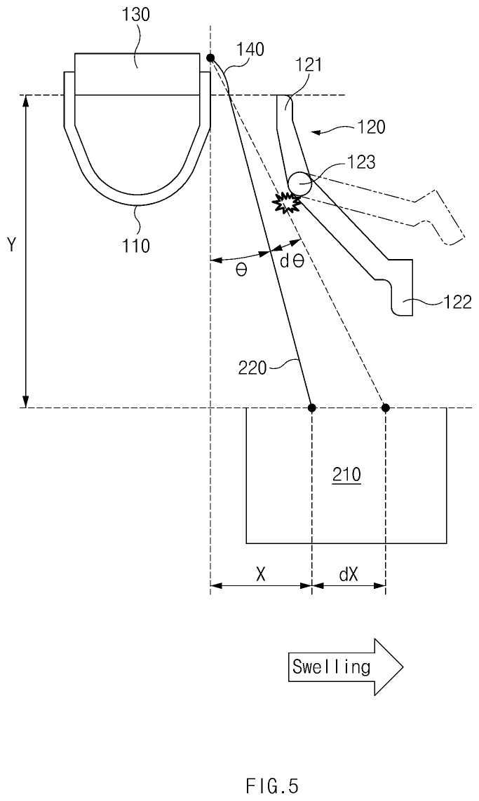

FIG. 5 is a view illustrating a principle of structural change during swelling of a battery module according to another embodiment of the present invention.

In a plurality of batteries 200, swelling may occur when gas in the secondary batteries is not completely removed during manufacture or an electrolyte in the secondary batteries is evaporated during utilization of the secondary batteries. When the swelling occurs in the plurality of batteries 200, the volume of plurality of batteries 200 may be increased, and when the volume is increased to a predetermined volume or greater, a position or load of each of other components of a battery module 100 may be affected.

The plurality of batteries 200 may each include a battery body 210 and a battery terrace 220. For example, the battery body 210 may have a shape in which an electrode assembly is included in a pouch. The battery terrace 220 may electrically connect the battery body 210 and the outside to each other.

A busbar 130 may be disposed on a first frame 110.

The busbar 130 may be connected to a lead 140. For example, the lead 140 may electrically connect the busbar 130 and the plurality of batteries 200 to each other.

The lead 140 may be connected to the battery terrace 220. For example, as the lead 140 and the battery terrace 220 are electrically connected to each other, the busbar 130 and the plurality of batteries 200 may be electrically connected to each other.

The lead 140 and the battery terrace 220 may form a connection part. For example, the connection part may be a part that applies force to a second frame 120 when the volume of the battery body 210 is increased to a predetermined volume or greater according to the swelling.

When the swelling phenomenon occurs, the battery body 210 may be deformed (or increase in volume) while expanding. For example, the battery body 210 before the swelling may have a shape in which the battery body 210 is spaced a fixed distance Y from the busbar 130 in a vertical direction and a center of the battery body 210 is spaced a fixed distance X from one end thereof. The battery body 210 before the swelling may be in a state in which the one end and the center of the battery body 210 form a fixed angle θ based on the specific busbar 130.

When the swelling occurs and the battery body 210 expands, the battery body 210 may be deformed so that the center of the battery body 210 is far away from the one end by a specific distance dX. In this case, the battery body 210 may be in a state in which the one end and the center of the battery body 210 form a specific angle θ-dθ based on the specific busbar 130.

When the volume of the battery body 210 mounted in an accommodation part 101 is increased to the predetermined volume or greater and the battery body 210 is deformed so that the center of the battery body 210 is far away from the one end by the specific distance dX, the connection part may move in a swelling direction and apply the force to the second frame 120. For example, at least one of a lead 140 or a battery terrace 220 may apply the force to the second frame 120.

When the at least one of the lead 140 or the battery terrace 220, which forms the connection part, applies the force to the second frame 120, the first member 121 fixed and coupled to the first frame 110 may not move.

When the at least one of the lead 140 or the battery terrace 220, which forms the connection part, applies the force to the second frame 120, the second frame 120 may rotate to the first member 121 in a direction in which the force is applied.

As described above, even when the volume of the batteries 200 is increased because of the swelling, the structure of the battery module may also adaptively change to cope with the volume change in battery module 100. Accordingly, an extra space may be secured to prevent the breakage of the secondary batteries.

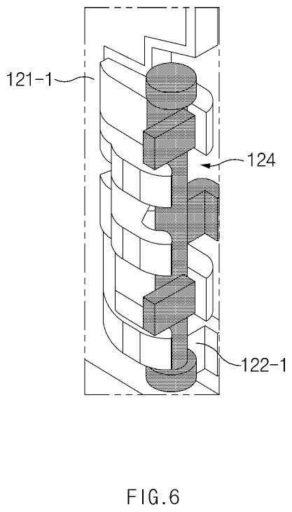

FIG. 6 illustrates a coupling shaft of a battery module according to embodiments of the present invention.

A first member 121 may be coupled to a second member 122. For example, the second member 122 may be pin-hook-coupled to the first member 121. The first member 121 and the second member 122 may be pin-hook-coupled to each other and form a coupling shaft 123.

The first member 121 may include a first coupling part 121-1. For example, the first member 121 may have one end including the first coupling part 121-1 to which the second member 122 is coupled.

The second member 122 may include a second coupling part 122-1. For example, the second member 122 may have one end including the second coupling part 122-1 formed to be coupled to the first member 121.

The first coupling part 121-1 may be formed so that the second coupling part 122-1 may be pin-hook-coupled thereto. For example, the first coupling part 121-1 may have an insertion space into which the second coupling part 122-1 may be inserted (or pin-inserted). The second coupling part 122-1 may be inserted into the insertion space formed in the first coupling part 121-1, and the second coupling part 122-1 may be hook-coupled to a hooking part that forms an outer appearance of the insertion space of the first coupling part 121-1.

The second coupling part 122-1 may include a protrusion formed to be hooked with the hooking part of the first coupling part 121-1. For example, the protrusion of the second coupling part 122-1 may be hooked with and hook-coupled to the hooking part of the first coupling part 121-1.

The second coupling part 122-1 may rotate within the insertion space of the first coupling part 121-1. For example, the second coupling part 122-1 may rotate in a state in which the second coupling part 122-1 is inserted into and hook-coupled to the insertion space of the first coupling part 121-1.

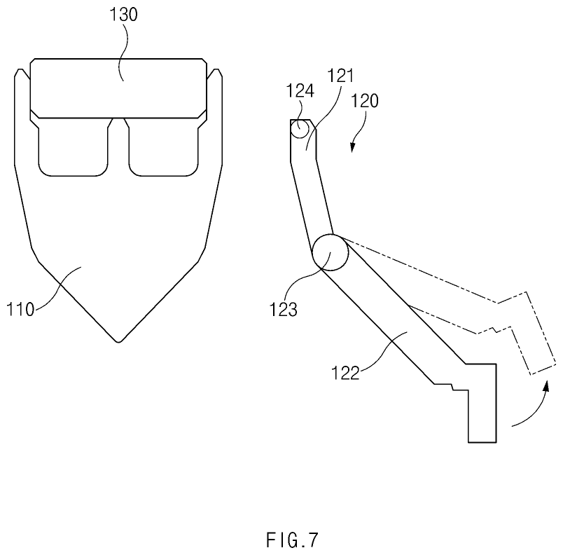

FIG. 7 illustrates a portion of a combinational relationship of a battery module according to another embodiment of the present invention.

A first member 121 may further include a frame coupling shaft 124 in order to further secure an extra space in the battery module.

The frame coupling shaft 124 may couple a first frame 110 and a second frame 120 to each other, and may be a coupling shaft that allows the second frame 120 to be rotatable with respect to the first frame 110.

The frame coupling shaft 124 may be formed in the first member 121 of the second frame 120. For example, the frame coupling shaft 124 may be formed at the other end of the first member 121, at which the first member 121 is coupled to the first frame 110.

When the first member 121 further includes the frame coupling shaft 124, the first member 121 may be rotatable with respect to the first frame 110. For example, when a connection part applies force to the second frame 120, not only a second member 122 but also the first member 121 may rotate with respect to the first frame 110. Specifically, the second member 122 may be rotatable with respect to the first member 121 or the first frame 110, and the first member 121 may be rotatable with respect to the first frame 110.

The description of the coupling shaft 123 may be applied to the specific structure of the frame coupling shaft 124.

As described above, according to the embodiments of the present invention, the extra space may be secured according to the structure that adaptively changes even when the volume of the secondary battery is increased because of the swelling. Accordingly, the breakage of the secondary battery may be prevented, and the risk of the occurrence of the fire or the explosion in the battery module may be reduced.

Although the present invention has been described with reference to the limited embodiments and drawings, the present invention is not limited thereto and may be variously implemented by those of ordinary skill in the art to which the present invention pertains, within the technical idea of the present invention and an equivalent of the appended claims.

### DESCRIPTION OF THE SYMBOLS

100: Battery module
101: Accommodation part
110: First frame
120: Second frame
121: First member
121-1: First coupling part
122: Second member
122-1: Second coupling part
123: Coupling shaft
124: Frame coupling shaft
130: Busbar
140: Lead
200: Battery
210: Battery body
220: Battery terrace

1. A battery module comprising:
a plurality of batteries, each of the plurality of batteries comprising a battery body and a battery terrace;
an accommodation part configured to accommodate the plurality of batteries;
a first frame configured to cover an upper portion of the accommodation part and support a busbar electrically connected to the battery terrace through a lead; and
a second frame configured to cover a lateral portion of the accommodation part and coupled to the first frame,
wherein the second frame comprises:
a first member coupled to the first frame; and
a second member coupled to the first member so as to be rotatable with respect to the first member in a direction in which the battery terrace or the lead of a first battery of the plurality of batteries applies force according to a change in volume of the plurality of batteries.

2. The battery module of claim 1, further comprising a coupling shaft configured to allow the second member to be rotatable with respect to the first member.

3. The battery module of claim 2, wherein the lead connects the busbar and the first battery to each other through a connection space provided between the first frame and the second frame.

4. The battery module of claim 1, wherein when a volume of the first battery is increased above a predetermined volume, the battery terrace or the lead is in contact with the second frame to apply the force to the second frame and thus, the second member rotates with respect to the first member in a direction in which the force is applied.

5. The battery module of claim 1, wherein an outermost battery of the plurality of batteries, which is disposed at an outermost side the plurality of batteries, is disposed to be adjacent to the second frame.

6. The battery module of claim 1, wherein the first member is coupled to the first frame so as to be rotatable with respect to the first frame in the direction in which the battery terrace or the lead of the first battery applies the force.

7. A module frame comprising:
an accommodation part configured to accommodate a plurality of batteries;
a first frame configured to cover an upper portion of the accommodation part and support a busbar from a lower side; and
a second frame configured to cover a lateral portion of the accommodation part and coupled to the first frame,
wherein the second frame comprises:
a first member coupled to the first frame; and
a second member coupled to the first member so as to be rotatable with respect to the first member in a direction in which an external force is received.

8. The module frame of claim 7, wherein the first member is coupled and fixed to the first frame.

9. The module frame of claim 7, wherein the first member is coupled to the first frame so as to be rotatable with respect to the first frame in the direction in which the external force is received.

10. The module frame of claim 7, wherein the second member is pin-hook-coupled to the first member.
